(19) United States
(12) Patent Application Publication
(10) Pub. No.: US 2005/0030860 A1
(43) Pub. Date: Feb. 10, 2005

(54) Method and system for optical medium power calibration

(76) Inventors: Donald B. Gage, Cedar Park, TX (US); Manuel Rivera JR., Austin, TX (US)

Correspondence Address: Robert W. Holland;HAMILTON & TERRILE, LLP, PO Box 203518, Austin, TX, 78720, US

(21) Appl. No.: 10/637,144

(22) Filed: Aug. 8, 2003

(51) Int. Cl. G11B 7/00

(52) U.S. Cl. 369/47.53; 369/53.2

(57) ABSTRACT

Power settings for writing information to an optical medium are adjusted to compensate for variations in the optical medium from expected characteristics, such as recording layer variations, disc tilt, variability in the outer versus inner diameter of an optical medium and write speed variations. An OPC process is performed at each of plural distributed locations of the optical medium, such as an inner diameter, middle diameter and outer diameter location, to determine a power setting at each location that writes information with the least amplitude and jitter variations. The determined power settings for the plural locations are averaged to determine an adjusted power setting for writing information to the optical medium. The adjusted power setting is saved in volatile or non-volatile memory for use in subsequent writes to optical medium having the same identification code.

### BACKGROUND OF THE INVENTION

1. Field of the Invention

The present invention relates in general to the field of storing information on optical media, and more particularly to a method and system for power calibration of an optical medium drive to write information to an optical medium.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information handling systems have grown more common, the quantity of information generated by businesses and individuals has increased. Writable and re-writable optical media have become common choices for storing these greater quantities of information by offering a combination of gigabyte storage capacity with convenience and portability. In response to the greater demand for optical media storage, optical disk drive and media manufacturers have sought to increase the quantity of information storable on optical media as well as the speed and accuracy with which the information is written. As optical disk drives are released with increased writing speeds, optical media manufacturers develop and release optical media formulated to have information written at the greater available writing speeds. Optical drive manufacturers test new media to determine write strategies, such as power settings for lasers, which will accurately and efficiently write information to each type of optical medium. The write strategies are typically determined from an average of test results for several samples of the medium and drive in use and are generally stored in optical drive firmware using an ATIP/ADIP/media table. Information written to a well-manufactured CD-RW medium by an optical drive applying an accurate write strategy typically shows data amplitude and jitter variations of less than 10%. Current DVD+RW media tend to have greater variations approaching 20%, and pending “blue” laser technology with its greater storage densities will likely have even greater sensitivity to recording variations caused by media variability, such as recording layer variations and disc tilt across a medium surface. Excessive variations in jitter and amplitude use margins designed to ensure accurate recording and can lead to errors in the writing of data.

One solution typically used by disk drives to reduce variations in jitter and amplitude is the Optimum Power Calibration (OPC) process. Optical drives perform OPC by selecting a write strategy for an inserted optical medium based on the ATIP code of the medium and then by writing test data at a defined location in the inner diameter of the medium using power settings varied around the selected write strategy. The test data is read as a modulated signal and the jitter and amplitude variations are analyzed to estimate a target power for an ideal modulated signal. OPC uses as its starting point the write strategy from the disk drive's firmware table for known media and a generic write strategy for unknown or new media. By adjusting power settings for data writes to account for variations in jitter and amplitude, OPC provides more efficient recording, avoids premature wear out of the optical medium and prevents over powering by the laser in writing to the medium that creates readability problems. However, OPC only adjusts a selected write strategy for conditions tested in the inner diameter of the optical medium.

### SUMMARY OF THE INVENTION

Therefore a need has arisen for a method and system which adjusts write strategy parameters for writing data to an optical medium based on variations in characteristics across the optical medium.

In accordance with the present invention, a method and system are provided which substantially reduce the disadvantages and problems associated with previous methods and systems for calibration of optical drive power settings for writing to an optical medium. A power calibration process is performed at multiple distributed locations of an optical medium to adjust the power setting of a write strategy associated with the optical medium.

More specifically, an optical disc drive laser reads the identification code from an inserted optical medium and obtains the write strategy associated with the identification code from a write strategy table. An OPC engine associated with the disc drive performs plural test writes and reads at plural locations distributed across the optical medium, such as inner, middle and outer diameter locations. The test writes vary power settings from the write strategy power setting and the test reads analyze the modulated signal from the test write data to identify an optimal power setting at each test write location that restricted amplitude reductions and jitter increases to the best levels. The optimal power settings for the test locations are averaged to determine an adjusted power setting for writing information from an information handling system to the optical medium for storage. The adjusted write strategy power setting may be stored in volatile or non-volatile memory of the optical drive or an associated information handling system for use in subsequent writes of information to optical media having the same identification code.

The present invention provides a number of important technical advantages. One example of an important technical advantage is that plural distributed power calibrations adjust write strategy parameters for writing data to an optical medium based on variations in characteristics across the optical medium. More accurate power settings are determined for writing information to the optical medium by testing for variations in optical medium characteristics across the medium. More accurate write power settings provide more uniform and reliable recording signal properties resulting in lower error rates and better repeated overwrite performance for know and unknown re-writable optical media. Distributed test writes for power calibration provide a more accurate power setting average value for use with default write strategies used on unknown media and for use with more sensitive media such as “blue laser” DVD media.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system and optical drive that adjusts write power settings; and

FIG. 2 depicts a process for adjusting the write power settings used to write information to a re-writable optical medium.

### DETAILED DESCRIPTION

Write strategy power settings for writing information from an information handling system to an optical medium are adjusted by the results of plural OPC processes run at plural distributed locations of the optical medium. For purposes of this application, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

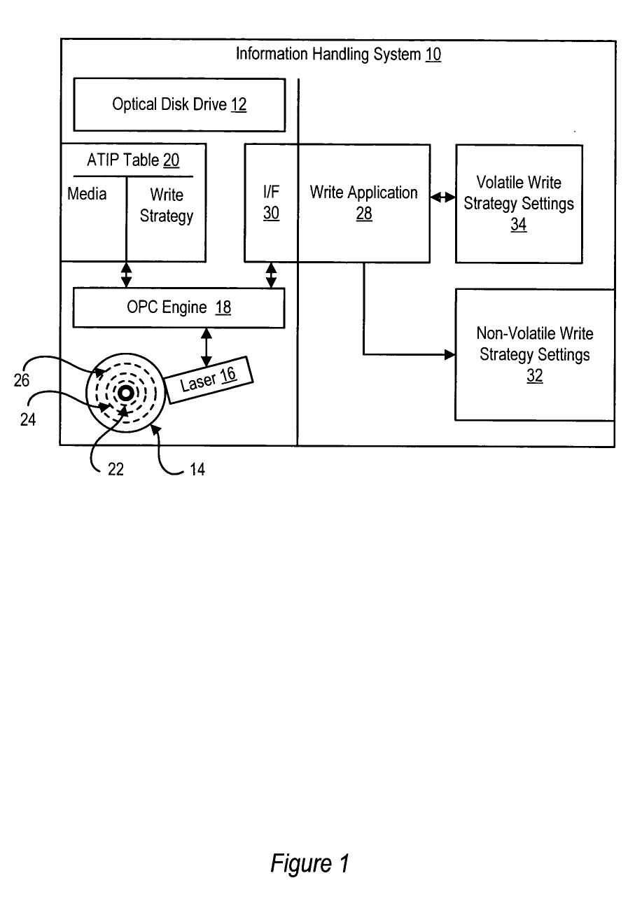

Referring now to FIG. 1, a block diagram depicts an information handling system 10 and optical drive 12 that adjusts write power settings based on plural OPC processes run at distributed locations of an optical medium 14. As optical medium 14 is inserted into optical disc drive 12, laser 16 reads an identification code from optical medium 14, such as the ATIP/ADIP code, and provides the identification code to an OPC engine 18. OPC engine 18 references write strategy ATIP/ADIP table 20 to determine the write strategy associated with optical media of the type indicated by the identification code. For instance, if the optical medium's identification code is found in write strategy table 20, the optical medium is a known medium and the write strategy associated with the identification code is used as the starting point for the OPC process. If the optical medium's identification code is not specifically found in write strategy table 20, then the optical medium is classified as new media that the optical drive manufacturer has not tested as part of the qualification of the optical drive. New media may be a known subtype of existing media that has an associated subtype generic write strategy, such as Ultra High Speed CD-RW media, or may be an unknown medium that uses a generic write strategy.

Once a write strategy is identified for medium 14, OPC engine 18 performs plural power calibrations at each of plural distributed optical medium locations. For instance, OPC engine 18 performs a power calibration by making test writes and reads at an inner diameter 22, middle diameter 24 and outer diameter 26 of optical medium 14. The test writes are performed at variations of the power setting of the write strategy identified for optical medium 14. For instance, a rough power calibration tuning of 5 writes is performed at each location with the test power settings bracketing the write strategy power setting. The modulated signal from the test writes is measured to estimate a target power for an ideal modulated signal in which amplitude reductions and jitter increases are minimized. OPC engine 18 determines an adjusted power setting by averaging the target powers determined for each of the plural distributed locations. Laser 16 is then adjusted to write information from information handling system 10 to optical medium 14 with the adjusted power setting. A write application 28 coordinates the transfer of information generated by processing components of information handling system 10 through interface 30 for writing to optical medium 14. Write application 28 stores the adjusted power setting in non-volatile write strategy settings 32, such as read only memory or a hard disc drive, or alternatively stores the adjusted power setting in volatile write strategy setting 34, such as random access memory. If a subsequent write of information is made to an optical medium having the same identification code, write application 28 provides OPC engine 18 with the adjusted write strategy power setting to avoid delays from another determination of an adjusted power setting.

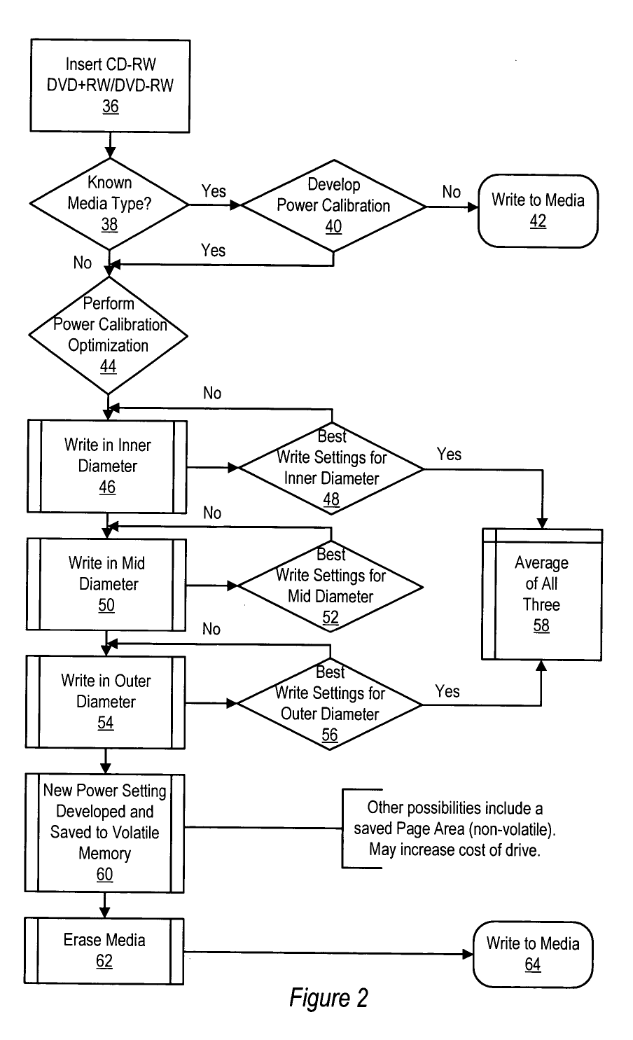

Referring now to FIG. 2, a process for adjusting the write power settings used to write information to a re-writable optical medium is depicted. The process begins at step 36 with the insertion of a re-writable optical medium into the optical drive, such as a CD-RW, DVD+RW or DVD-RW disc. Test writes to re-writable optical media may be performed at defined or random locations across a medium since the test data is blanketed or erased by subsequent information writes. Although the use of plural test writes to distributed locations of writable optical media, such as CDR, DVD-R or DVD+R media, will provide an improved adjusted power setting, subsequent writes of information to the writable disc will have to avoid areas written by test data. Alternatively, after power calibration of a writable optical medium, the test optical medium is discarded and the information written to a new disc with the same identification code. At step 38, a determination is made of whether the inserted medium is of a known or unknown type. If the medium is a known type, the process continues to step 40 at which the user of the information handling system may select whether or not to perform power calibration. For instance, if the ATIP/ADIP identification code indicates a media type of marginal quality, a power calibration may be selected at step 44 to improve information writes while media types of higher quality may proceed to information writing at step 42 without the delay caused by power calibration. If the determination at step 38 is that the medium is of an unknown type, the process continues to step 44 for power setting calibration.

Write power setting calibration begins at steps 46 and 48 with sequential test writes and test reads at the inner diameter of the optical medium to determine the best write power setting for the inner diameter. Test writes may be performed at one time with predetermined variations of the write strategy power setting, such as a test write at the write strategy power setting, two test writes at defined increments above and two below the write strategy power setting. The best write power setting is determined by analysis of the modulated signal amplitude and jitter variations. The power calibration process repeats at steps 50 and 52 for the middle diameter of the optical medium, and repeats again at steps 54 and 56 for the outer diameter of the optical medium. In alternative embodiments, additional test writes at additional optical medium locations may be performed as desired to measure variability across the optical medium. Further, the number of test writes for a given optical medium location may be increased if greater accuracy of the write power setting is desired. At step 58, the best write power settings for the inner, middle and outer diameters are averaged to determine an adjusted write power setting for writing information for storage on the optical medium. The process continues to step 60 at which the adjusted power setting is saved to volatile or non-volatile memory of the optical drive or an associated information handling system for use with subsequent writes of information to optical media having the same identification code as the optical medium for which the adjusted write power setting was developed. At step 62, the test data that was written to determine the adjusted power setting is erased, and at step 64 information for storage on the optical medium is written using the adjusted power setting.

Although the present invention has been described in detail, it should be understood that various changes, substitutions and alterations can be made hereto without departing from the spirit and scope of the invention as defined by the appended claims.

1. An information handling system comprising:
processing components operable to generate information for storage on an optical medium;
an optical disk drive interfaced with the processing components and operable to process the information for writing to the optical medium;
a write strategy table having plural write strategies, each write strategy associated with one or more optical medium types;
a laser associated with the optical disk drive and operable to illuminate the optical medium to burn information onto the optical medium with a write strategy associated with the optical medium or to read information from the optical medium; and
an OPC engine interfaced with the write strategy table and the laser, the OPC engine operable to perform test writes and reads at plural distributed locations of the optical medium, the test writes having predetermined variations of the write strategy associated with the optical medium, the OPC engine adjusting the write strategy to write the generated information to the optical medium based on the quality of modulated signals read from the test writes at the distributed locations.

2. The information handling system of claim 1 wherein the OPC engine test writes are to an inner diameter track, middle diameter track and outer diameter track of the optical medium.

3. The information handling system of claim 2 wherein variations of the write strategy comprise write power variations and wherein the OPC adjusts the write strategy to write the generated information to an average of the write power at each of the inner, middle and outer diameter tracks that provided a modulated signal having the least amplitude and jitter variations.

4. The information handling system of claim 2 wherein the optical medium comprises a DVD-RW disc.

5. The information handling system of claim 2 wherein the optical medium comprises a DVD+RW disc.

6. The information handling system of claim 2 wherein the optical medium comprises a CD-RW disc.

7. The information handling system of claim 1 further comprising volatile memory interfaced with the optical disc drive and operable to store the adjusted write strategy for use on a subsequent write to an optical medium of the same type.

8. The information handling system of claim 1 further comprising non-volatile memory interfaced with the optical disc drive and operable to store the adjusted write strategy for use on a subsequent write to an optical medium of the same type.

9. The information handling system of claim 8 wherein the non-volatile memory comprises the hard disc drive.

10. A method for re-writable optical medium write power calibration, the method comprising:
determining a write strategy from an identification code of an optical medium;
performing test writes and reads at plural locations distributed across the optical medium, the test writes having predetermined variations from the power setting of the write strategy;
analyzing the modulated signal read from each test read to determine the power setting variation at each location having the least amplitude and jitter variations;
averaging the determined power setting variations for the locations to determine an adjusted write strategy; and
writing information to the re-writable optical medium with the adjusted write strategy.

11. The method of claim 10 wherein the re-writable optical medium comprises a DVD-RW disc.

12. The method of claim 10 wherein the re-writable optical medium comprises a DVD+RW disc.

13. The method of claim 10 wherein the re-writable optical medium comprises a CD-RW disc.

14. The method of claim 10 wherein the re-writeable optical medium comprises an unknown medium and the write strategy comprises a generic write strategy.

15. The method of claim 10 wherein the re-writable optical medium comprises a new medium and the write strategy comprises a generic write strategy associated with a type of re-writable optical medium.

16. The method of claim 10 further comprising:
storing the adjusted write strategy in volatile memory; and
writing information to another re-writable optical medium having the identification code by using the adjusted write strategy.

17. The method of claim 10 wherein performing test writes further comprises performing test writes at an inner diameter, middle diameter and outer diameter location of the optical medium.

18. A system for re-writable optical medium write power calibration, the system comprising:
a write strategy table associating re-writable optical medium identification codes and write strategies, each write strategy having a write power setting; and
an OPC engine interfaced with the write strategy table, the OPC engine operable to determine a write strategy for an optical medium from the write strategy table and to adjust the determined write strategy's write power setting by performing test writes and reads at plural distributed locations of the optical medium, determining the power setting at each location that had the lowest read amplitude and jitter variations, and averaging the determined power settings to determine the adjusted write power setting.

19. The system of claim 18 wherein the determined write strategy for the optical medium comprises a generic write strategy.

20. The system of claim 19 further comprising memory interfaced with the OPC engine and operable to store the adjusted write power setting for use with a write to a subsequent optical medium having the same identification code.

21. The system of claim 18 wherein the optical medium comprises a blue laser re-writable disc.
